(19) United States
(12) Patent Application Publication
(10) Pub. No.: US 2025/0229201 A1
(43) Pub. Date: Jul. 17, 2025

(54) Ergonomic Kitchen Sink Cleaning Tool with Debris-Collecting Mesh and Dual-Material Frame

(71) Applicant: Jonathan Zacharias Bror Lindén, Saltsjo-bbo (SE)

(72) Inventor: Jonathan Zacharias Bror Lindén, Saltsjo-bbo (SE)

(21) Appl. No.: 18/410,890

(22) Filed: Jan. 11, 2024

(51) Int. Cl. B01D 29/96; B01D 29/03

(52) U.S. Cl. CPC B01D 29/96; B01D 29/03

(57) ABSTRACT

This invention pertains to a cleaning tool designed for kitchen sink use, aimed at simplifying the process of debris collection and removal. This tool features a unique design incorporating a handle with an integral frame which consists of several panels that houses a mesh floor. The mesh floor is adept at retaining debris while allowing liquids to pass through. A notable aspect of the tool is the frame's construction, comprising an inner solid core and a softer outer layer, typically silicone, enhancing ergonomic comfort. The mesh is made from materials like stainless metal or synthetic material offering durability and efficiency. The handle's curved design with an aperture aids in easy gripping. The tool's panels are wedge-shaped, effectively channeling debris towards the mesh floor. This invention presents an innovative approach to kitchen cleaning, combining functional efficiency with user-friendly design.

### FIELD OF INVENTION

The present invention relates generally to the field of kitchen cleaning tools. Specifically, it relates to a specialized tool designed for collecting debris in kitchen sinks.

### BACKGROUND

In the realm of kitchen maintenance, particularly the management of waste and debris in sinks, existing solutions often fall short in efficiency and effectiveness. Traditional methods of clearing sink debris, which typically involve the use of basic sponges, brushes, or sink strainers, present several limitations. For instance, conventional sponges and brushes, while effective for surface cleaning, are inadequate for collecting and removing finer particles and fats that accumulate in kitchen sinks. These smaller particles often bypass standard strainers and contribute to drain clogs, requiring additional maintenance and potentially professional intervention.

Moreover, the design of existing tools is often not optimized for the dynamics of a kitchen sink. The majority of sink cleaning tools do not account for the varying viscosities of liquids and the need to separate solid debris from these liquids efficiently. As a result, users frequently experience difficulties in preventing clogs and ensuring a thorough clean-up of their sink area.

Another significant challenge lies in the ergonomic design of these tools. Many current cleaning tools do not offer a comfortable or effective grip, which can lead to user fatigue or discomfort, especially during extended use. The lack of a well-designed handle and a body conducive to maneuvering around the sink area further complicates the cleaning process.

Additionally, the materials used in current sink cleaning tools often do not strike an optimal balance between durability and safety for delicate surfaces. Tools with hard materials can damage the sink surface, while those made from softer materials may lack the necessary robustness for effective scraping and collection of debris.

These limitations underscore the need for a cleaning tool specifically designed for kitchen sink use. Such a tool would ideally address the inefficiencies of existing methods by providing an effective way to collect both large and fine debris and fats, thus preventing drain clogs and facilitating easier cleaning.

It is within this context that the present invention is provided.

### BRIEF SUMMARY OF THE INVENTION

The present invention relates to a cleaning tool, particularly designed for use in kitchen environments. This invention comprises a frame and handle, together forming the tool's body. The frame is made up of several panels, with a mesh floor attached to these panels. The mesh floor is specifically designed to retain debris while allowing the passage of liquids, thereby facilitating an efficient cleaning process.

This invention's novelty is in its tool body design, featuring a dual-layer structure. The inner core, made of solid materials like plastic or metal, provides strength and rigidity. Encasing this is an outer layer, made out of silicone or a similar soft material, enhancing grip and comfort. This outer layer also augments the panels' scraping efficacy on kitchen sink surfaces. The dual-layer approach can be applied to both the frame and handle or exclusively to the panels, with the handle maintaining a singular solid material composition throughout. The mesh floor of the tool can be made from metal, non-stick, or synthetic materials with properties that prevent bonding with fats, making it easier to clean the tool after use.

Another feature of the tool is its mesh floor, which is a separate component from the frame but attached to it, enhancing the functionality of the cleaning tool. This mesh is constructed from materials such as stainless steel, nylon, silicone, polyethylene, polypropylene, and combinations thereof, or a similar material as mentioned, or combinations thereof, allowing for flexibility in design and use. All materials mentioned have properties that prevent it from bonding with fats.

The handle of the tool is ergonomically crafted with a curved arch, featuring an aperture for comfortable gripping, aimed at reducing user discomfort during extended use. The tool's body extends beyond the handle's width, offering extra space and minimizing finger pinching risks. An alternative design for the handle is a simple arch without any extension beyond its curve, which can be designed with or without an aperture, providing a different ergonomic approach.

Another aspect of the tool is the design of the surrounding panels. The distal, left, and right panels are wedge-shaped, sloping inwards toward the of the mesh floor, effectively guiding debris towards the mesh for easy collection. The proximal panel, forming the upper part of the frame, is also integrated into the handle's structure. This panel can either share the wedge-shape of the other panels, or its inner side may be perpendicular to the front side of said panel.

Furthermore, the cleaning tool is designed with user safety in mind, featuring rounded edges and corners, including on the frame, to minimize the risk of injury during use. The mesh floor of the tool may also include a non-stick coating, further enhancing its functionality and ease of cleaning.

### BRIEF DESCRIPTION OF THE DRAWINGS

Various embodiments of the invention are disclosed in the following detailed description and accompanying drawings.

FIG. 1 illustrates an isometric front view of the cleaning tool, showcasing the general design and structure.

FIG. 2 illustrates a front perspective view of the tool, emphasizing its design characteristics and proportions.

FIG. 3 illustrates an isometric rear view.

FIG. 4 illustrates a rear perspective view of the tool.

FIG. 5 illustrates a cross-sectional side view of the tool.

FIG. 6 illustrates an isometric front view of a second alternative embodiment of the cleaning tool, showcasing a wider handle structure.

Common reference numerals are used throughout the figures and the detailed description to indicate like elements. One skilled in the art will readily recognize that the above figures are examples and that other architectures, modes of operation, orders of operation, and elements/functions can be provided and implemented without departing from the characteristics and features of the invention, as set forth in the claims.

### DETAILED DESCRIPTION OF THE INVENTION

The following is a detailed description of exemplary embodiments to illustrate the principles of the invention. The embodiments are provided to illustrate aspects of the invention, but the invention is not limited to any embodiment. The scope of the invention encompasses numerous alternatives, modifications and equivalent; it is limited only by the claims.

Numerous specific details are set forth in the following description in order to provide a thorough understanding of the invention. However, the invention may be practiced according to the claims without some or all of these specific details. For the purpose of clarity, technical material that is known in the technical fields related to the invention has not been described in detail so that the invention is not unnecessarily obscured.

The terminology used herein is for the purpose of describing particular embodiments only and is not intended to be limiting of the invention.

As used herein, the term “and/or” includes any combinations of one or more of the associated listed items.

As used herein, the singular forms “a,” “an,” and “the” are intended to include the plural forms as well as the singular forms, unless the context clearly indicates otherwise.

It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

As used herein, the term “frame” refers to the structural panels to which the mesh floor of the tool is attached. This definition clarifies the role of the frame in the overall construction of the tool, emphasizing its importance in supporting the mesh floor.

The term “handle,” as used herein, denotes the part of the cleaning tool specifically designed for gripping by a user. The handle may be formed integrally with the frame and is configured for ergonomic handling and manipulation of the tool during use.

As used herein, the term “mesh floor” refers to a grid or net-like structure within the body of the cleaning tool, designed to retain debris while allowing the passage of liquids. The mesh floor is a key element in the functionality of the tool, enabling efficient cleaning and debris collection.

The present disclosure relates to a cleaning tool specifically designed for use in kitchen environments, particularly focusing on the efficient collection and removal of debris from kitchen sinks.

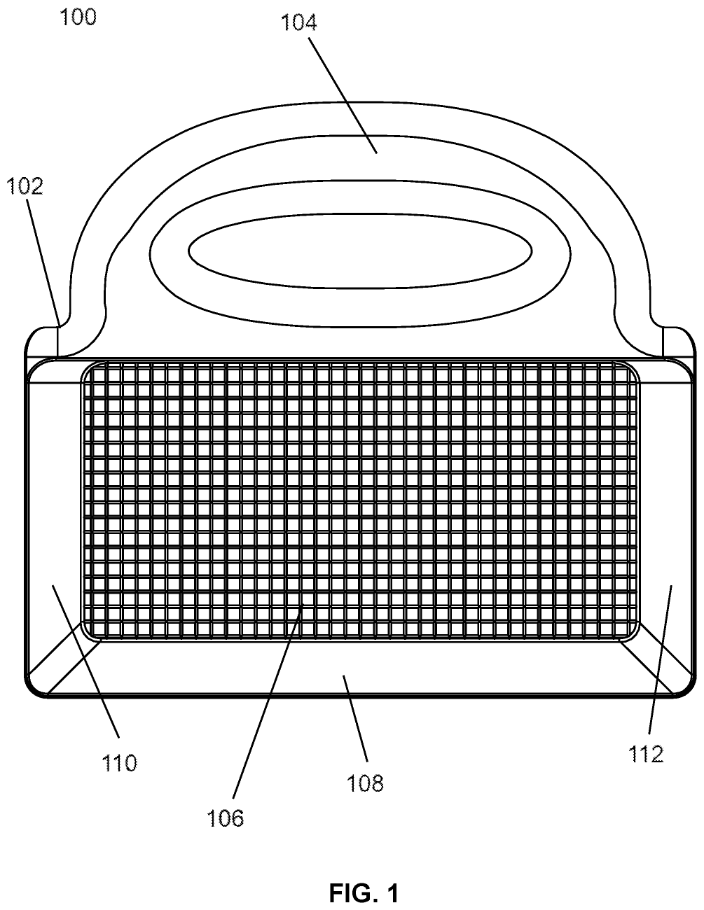

The present detailed description refers to the accompanying drawings wherein like reference numerals refer to like parts throughout. FIGS. 1-5 illustrate various perspectives of an embodiment of a cleaning tool (100), intended for use in kitchen environments for efficient debris collection.

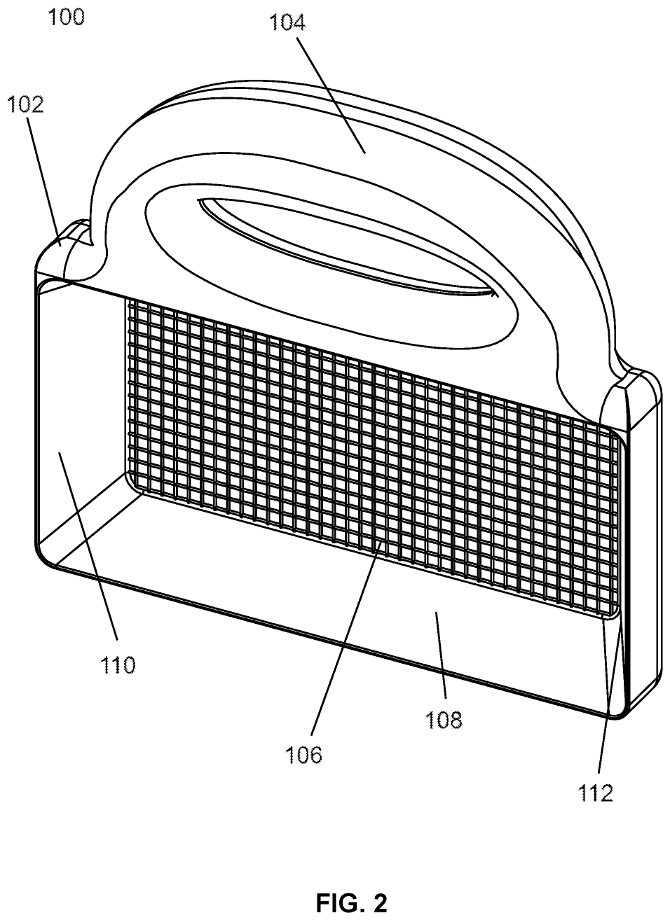

FIG. 1 presents an isometric front view of the cleaning tool 100, showcasing its overall structure and design. The tool comprises a frame 102 that is connected to an arched handle grip 104. The handle grip 104 features an ellipsoid aperture, which is ergonomically designed for easy holding and maneuvering of the tool during use. The inner surfaces of the distal panel 108, the left panel 110, and the right panel 112 are all sloped in towards the mesh floor 106 to allow easy scraping and collection of debris. FIG. 2 offers an isometric front perspective view of the tool 100, providing a clearer understanding of the spatial relationship between the different components.

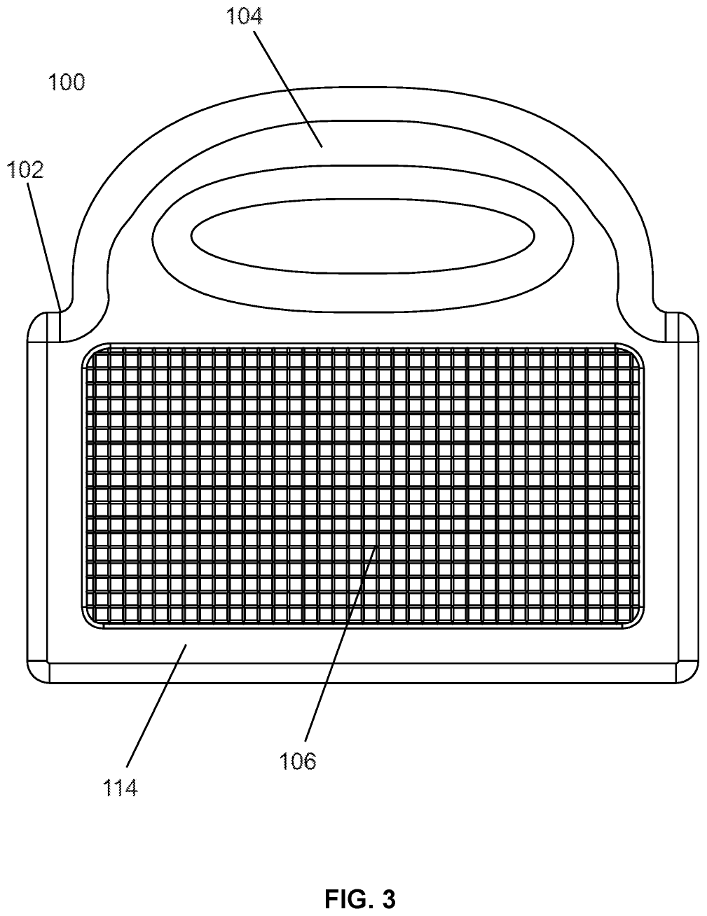

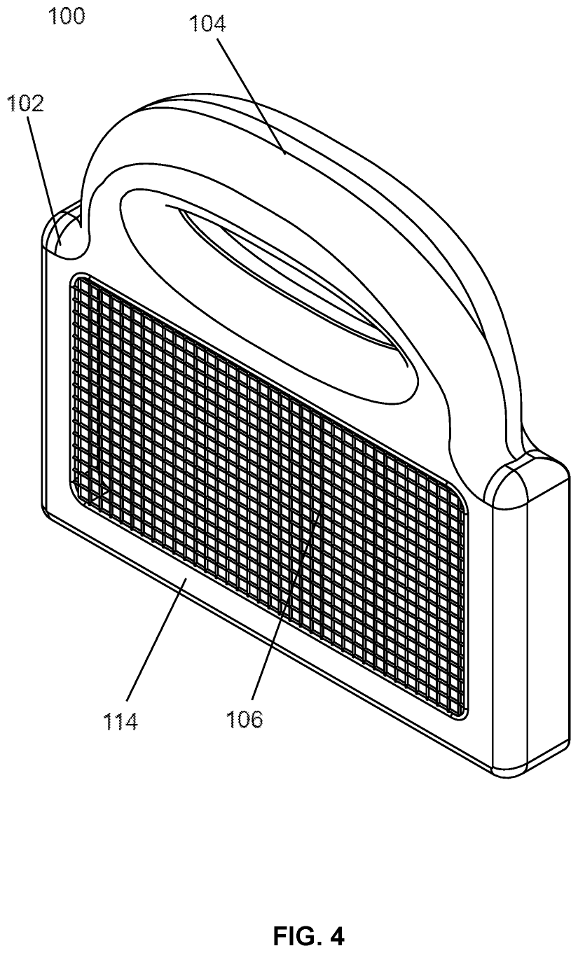

In FIG. 3, an isometric rear view of the tool 100 is depicted. This view particularly reveals the flat rear surface 114 of the frame and mesh. 114 represents the back side of the four panels: right, left, distal and proximal. The handle has a symmetrical design, looking the same from both the front and back views. FIG. 4 shows an isometric rear perspective view of the tool 100.

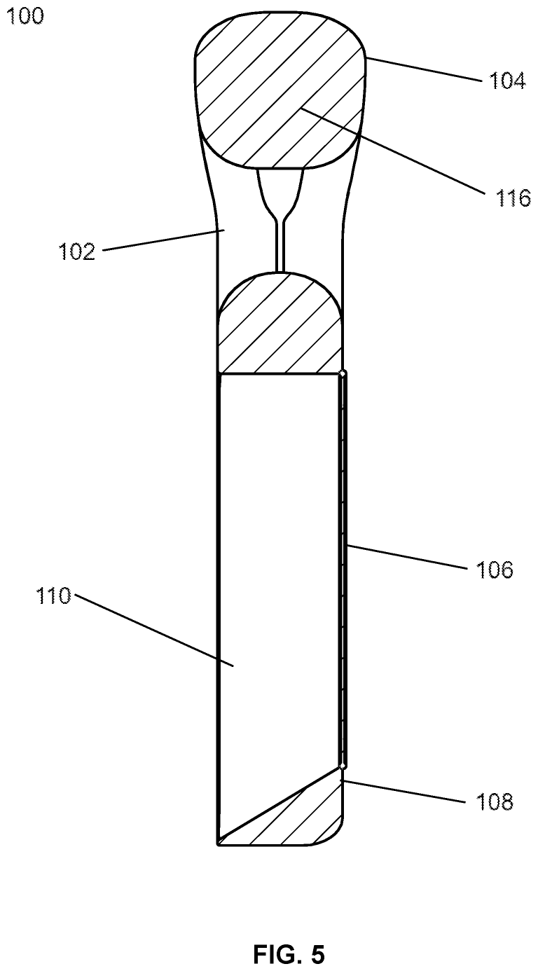

FIG. 5 presents a cross-sectional side view of the cleaning tool 100. This view highlights the handle's cross-sectional side and the triangular wedge shape formed by the distal panel, part of the frame 108. This wedge shape is instrumental in directing debris towards the mesh floor 106, thereby enhancing the tool's debris collection efficiency.

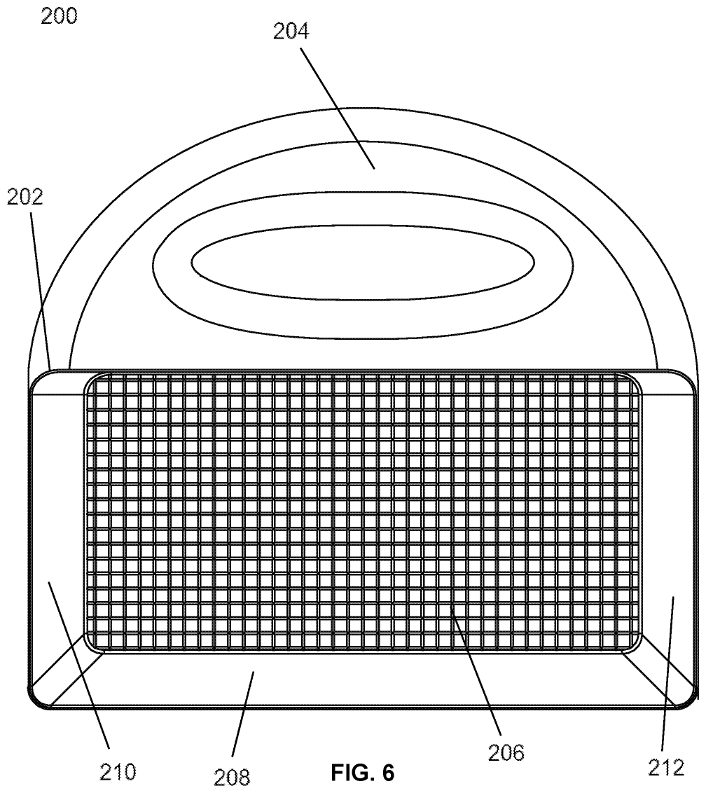

FIG. 6 presents an isometric front view of a second example design of the cleaning tool 200. The tool 200 is structured similarly to the first embodiment, but has a wider arc to the handle 204, such that there are no protruding edges of the frame 202. The inner surfaces of the distal panel 208, the left panel 210, and the right panel 212 are all sloped in towards the mesh floor 206 to allow easy scraping and collection of debris, as with the first embodiment.

Unless otherwise defined, all terms (including technical terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

The disclosed embodiments are illustrative, not restrictive. While specific configurations of the cleaning tool of the invention have been described in a specific manner referring to the illustrated embodiments, it is understood that the present invention can be applied to a wide variety of solutions which fit within the scope and spirit of the claims. There are many alternative ways of implementing the invention.

It is to be understood that the embodiments of the invention herein described are merely illustrative of the application of the principles of the invention. Reference herein to details of the illustrated embodiments is not intended to limit the scope of the claims, which themselves recite those features regarded as essential to the invention.

What is claimed is:

1. A cleaning tool for use in a kitchen environment, comprising:
a frame composed of several panels;
a handle;
a body formed by the handle and the frame; and
a mesh floor attached to and enclosed by the frame;
wherein the mesh is designed to capture and retain debris while allowing liquids to pass through; and
wherein each panel of the frame has a wedge-shaped profile, angled to direct guide debris towards the mesh floor for collection.

2. The cleaning tool of claim 1, wherein the frame features a dual-layer design with an inner core of a solid material and an outer layer, composed of a softer material and handle is entirely made from a solid material.

3. The cleaning tool of claim 1, wherein both the frame and handle feature a dual-layer design with an inner solid core and a softer outer layer.

4. The cleaning tool of claim 1, wherein the mesh floor is constructed from a synthetic material or metal, or a combination thereof.

5. The cleaning tool of claim 1, wherein the mesh floor is made from a material that has properties that prevent it from bonding with fats.

6. The cleaning tool of claim 1, wherein the handle is designed with a curved arch and includes an aperture for gripping.

7. The cleaning tool of claim 1, wherein the handle is designed with a curved arch and no aperture.

8. The cleaning tool of claim 1, wherein the body of the tool extends out wider than the width of its arched handle.

9. The cleaning tool of claim 1, wherein the frame of the tool is designed with four corners.

10. The cleaning tool of claim 1, which is designed with user safety in mind, incorporating rounded edges and corners on the frame.

11. In the cleaning tool of claim 1, the distal, proximal, left, and right panels are wedge-shaped from the front perspective, with their inner edges sloping toward the mesh floor and their rear sides flat.

12. In the cleaning tool of claim 1, the distal, left, and right panels are wedge-shaped from the front perspective, with their inner edges sloping toward the mesh floor and their rear sides flat. The proximal panel has an inner side angled perpendicularly to the front side of the panel.
